(19) United States
(12) Patent Application Publication
(10) Pub. No.: US 2026/0169319 A1
(43) Pub. Date: Jun. 18, 2026

(54) PHASE SHIFTERS INCLUDING AN ELECTRO-OPTIC MATERIAL

(71) Applicant: GlobalFoundries U.S. Inc., Malta, NY (US)

(72) Inventor: Yusheng Bian, Ballston Lake, NY (US)

(21) Appl. No.: 18/978,072

(22) Filed: Dec. 12, 2024

(51) Int. Cl. G02F 1/035

(52) U.S. Cl. CPC G02F 1/035; G02F 2202/30

(57) ABSTRACT

Structures for a phase shifter and methods of forming such structures. The structure comprises a waveguide core and a metamaterial structure laterally adjacent to the waveguide core. The metamaterial structure includes a first plurality of portions and a second plurality of portions that alternate with the first plurality of portions. The waveguide core comprises an electro-optic material, the first plurality of portions comprise a first material having a first refractive index, and the second plurality of portions comprise a second material having a second refractive index that is less than the first refractive index.

### BACKGROUND

This disclosure relates to photonic chips and, more specifically, to structures for a phase shifter and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

A phase shifter is a photonic component that can be used in a photonic integrated circuit to modulate the phase of light propagating in a waveguide core. Phase shifters operating by an electro-optic mechanism have the functionality to control the phase of the light through a change in the effective refractive index of the waveguide core. Conventional modulators based on electro-optic phase shifters cannot achieve a bandwidth that is adequately high with acceptable modulation efficiency.

Improved structures for a phase shifter and methods of forming such structures are needed.

### SUMMARY

In an embodiment of the invention, a structure for a phase shifter is provided. The structure comprises a waveguide core and a metamaterial structure adjacent to the waveguide core. The metamaterial structure includes a first plurality of portions and a second plurality of portions that alternate with the first plurality of portions, The waveguide core comprises an electro-optic material, the first plurality of portions comprise a first material having a first refractive index, and the second plurality of portions comprise a second material having a second refractive index that is less than the first refractive index.

In an embodiment of the invention, a method of forming a structure for a phase shifter is provided. The method comprises forming a waveguide core comprising an electro-optic material, and forming a metamaterial structure adjacent to the waveguide core. The metamaterial structure includes a first plurality of portions and a second plurality of portions that alternate with the first plurality of portions, the first plurality of portions comprise a first material having a first refractive index, and the second plurality of portions comprise a second material having a second refractive index that is less than the first refractive index.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 1A is a cross-sectional view taken generally along line 1A-1A in FIG. 1.

FIG. 2 is a cross-sectional view of the structure at a fabrication stage of the processing method subsequent to FIGS. 1, 1A.

FIG. 3 is a top view of a structure in accordance with embodiments of the invention.

FIG. 4 is a top view of a structure in accordance with embodiments of the invention.

FIG. 5 is a cross-sectional view of a structure in accordance with embodiments of the invention.

FIG. 6 is a cross-sectional view of a structure in accordance with embodiments of the invention.

FIG. 7 is a top view of a structure in accordance with embodiments of the invention.

### DETAILED DESCRIPTION

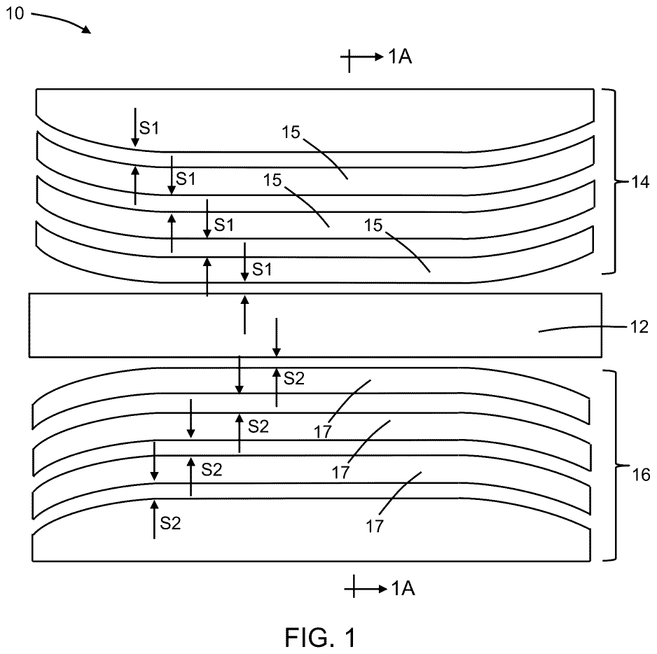

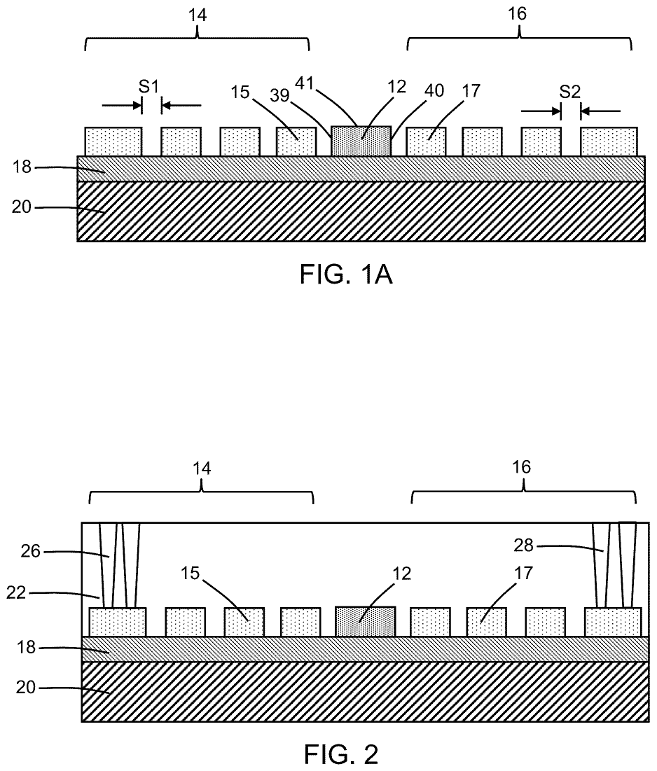

With reference to FIGS. 1, 1A and in accordance with embodiments of the invention, a structure 10 for an electro-optic phase shifter includes a waveguide core 12, a metamaterial structure 14, and a metamaterial structure 16 that are positioned on, and overlie, a dielectric layer 18 and a semiconductor substrate 20. In an embodiment, the dielectric layer 18 may be comprised of a dielectric material, such as silicon dioxide, and the semiconductor substrate 20 may be comprised of a semiconductor material, such as single-crystal silicon. In an embodiment, the dielectric layer 18 may be a buried oxide layer of a silicon-on-insulator substrate. The dielectric layer 18 may provide low-index cladding that separates the waveguide core 12, the metamaterial structure 14, and the metamaterial structure 16 from the semiconductor substrate 20. In an alternative embodiment, a sealed undercut may be formed in the semiconductor substrate 20 beneath the waveguide core 12 and the metamaterial structures 14, 16.

The waveguide core 12 is arranged in a lateral direction between the metamaterial structure 14 and the metamaterial structure 16. The waveguide core 12 has a sidewall 39 that is positioned adjacent to the metamaterial structure 14, a sidewall 40 opposite from the sidewall 39 and adjacent to the metamaterial structure 16, a top surface 41 between the opposite sidewalls 39, 40, and a bottom surface opposite from the top surface 41 and adjacent to the dielectric layer 18. In an embodiment, the bottom surface of the waveguide core 12 may be in direct contact with a portion of the dielectric layer 18. The distance between the sidewall 39 and the sidewall 40 represents a width dimension of the waveguide core 12, and the distance between the top surface 41 and the bottom surface represents a thickness of the waveguide core 12.

The metamaterial structure 14 may include portions in the form of multiple waveguide cores 15 that are separated by slots S1, as indicated by the spaces between the single-headed arrows. Each waveguide core 15 may include a straight central portion, and the straight central portions of the waveguide cores 15 may be arranged with progressively increasing distance from an adjacent portion of the waveguide core 12. Each waveguide core 15 may include end portions that curve away from the waveguide core 12 in order to provide adiabatic transitions. In an embodiment, each waveguide core 15 may have a bottom surface in direct contact with a portion of the dielectric layer 18.

The metamaterial structure 16 may include multiple waveguide cores 17 as portions that are separated by slots S2, as indicated by the spaces between the single-headed arrows. Each waveguide core 17 may include a straight central portion, and the straight central portions of the waveguide cores 17 may be arranged with progressively increasing distance from an adjacent portion of the waveguide core 12. Each waveguide core 17 may include end portions that curve away from the waveguide core 12 in order to provide adiabatic transitions. In an embodiment, each waveguide core 17 may have a bottom surface in direct contact with a portion of the dielectric layer 18.

The waveguide core 12 may be comprised of a material that exhibits tunable or dynamic photonic properties in response to an applied stimulus, such as an electric field. In an embodiment, the material constituting the waveguide core 12 may be an electro-optic material that exhibits an electric-field-induced Pockels effect in which the refractive index varies in proportion to the strength of an applied stimulus, such as an electric field, according to a characteristic electro-optic coefficient. In an embodiment, the waveguide core 12 may be comprised of a crystalline material that lacks inversion symmetry and that is characterized by an optic axis having a refractive index is controllable by an applied electric field.

In an embodiment, the electro-optic material may be lithium niobate, lithium niobate doped with magnesium oxide, lithium tantalate, or barium titanate. In alternative embodiments, the electro-optic material may be a binary or ternary III-V compound semiconductor material, such as gallium nitride, indium gallium nitride, indium phosphide, indium gallium arsenide, gallium arsenide, indium arsenide, or indium gallium phosphide. In an alternative embodiment, the electro-optic material may be an electro-optic polymer. In an alternative embodiment, the electro-optic material may be a phase change material. In an alternative embodiment, the electro-optic material may be a two-dimensional material, such as graphene.

In an embodiment, the waveguide core 12 may be formed by patterning a layer comprised of its constituent material with lithography and etching processes. In an alternative embodiment, a partially-etched slab layer, which is thinner than the waveguide core 12, may be formed during patterning and may be connected to a lower portion of the waveguide core 12.

In an embodiment, the waveguide cores 15 of the metamaterial structure 14 and the waveguide cores 17 of the metamaterial structure 16 may be comprised of a material having a refractive index that is greater than the refractive index of silicon dioxide. In an embodiment, the waveguide cores 15 and the waveguide cores 17 may be comprised of a semiconductor material, such as single-crystal silicon, amorphous silicon, or polysilicon. In an embodiment, the waveguide cores 15 and the waveguide cores 17 may be comprised of a doped semiconductor material, such as doped single-crystal silicon, doped amorphous silicon, or doped polysilicon.

In an embodiment, the waveguide cores 15 and the waveguide cores 17 may be formed by patterning a layer comprised of their constituent material with lithography and etching processes. In an embodiment, an etch mask may be formed by a lithography process over the layer, and unmasked sections of the layer may be etched and removed with an etching process. In an embodiment, the waveguide cores 15 and the waveguide cores 17 may be formed by patterning the semiconductor material (e.g., single-crystal silicon) of the device layer of a silicon-on-insulator substrate. In an alternative embodiment, a slab layer, which is thinner than the waveguide cores 15, may be connected to lower portions of the waveguide cores 15. In an alternative embodiment, a slab layer, which is thinner than the waveguide cores 17, may be connected to lower portions of the waveguide cores 17. In an embodiment, the waveguide cores 15 and the waveguide cores 17 may have a thickness that differs from the thickness of the waveguide core 12 due at least in part to their formation by distinct patterning processes.

With reference to FIG. 2 in which like reference numerals refer to like features in FIGS. 1, 1A and at a subsequent fabrication stage, a dielectric layer 22 may be formed over the waveguide core 12, the waveguide cores 15, and the waveguide cores 17. The dielectric layer 22 may be comprised of a dielectric material, such as silicon dioxide, having a refractive index that is less than the refractive index of the electro-optic material constituting the waveguide core 12, and that is also less than the material of the waveguide cores 15 of the metamaterial structure 14 and the waveguide cores 17 of the metamaterial structure 16.

The metamaterial structure 14 includes the portions of the dielectric material of the dielectric layer 22 that are positioned in the slots S1 between adjacent pairs of the waveguide cores 15. The portions of dielectric material of the dielectric layer 22 alternate with the portions of the material constituting the waveguide cores 15 with increasing distance from the waveguide core 12. The dielectric material of the dielectric layer 22 is characterized by a refractive index that is less than the refractive index of the material constituting the waveguide cores 15. The alternating portions of the material constituting the waveguide cores 15 and the dielectric material of the dielectric layer 22 produce a refractive index for the metamaterial structure 14 alternates between a relatively higher value and a relatively lower value with increasing distance in a lateral direction from the waveguide core 12. The metamaterial structure 14 may be treated as a homogeneous material having an effective refractive index that is intermediate between the refractive index of the material constituting the waveguide cores 15 and the refractive index of the dielectric material constituting the dielectric layer 22.

The metamaterial structure 16 includes the portions of the dielectric material of the dielectric layer 22 that are positioned in the slots S2 between adjacent pairs of the waveguide cores 17. The portions of dielectric material of the dielectric layer 22 alternate with the portions of the material constituting the waveguide cores 17 with increasing distance from the waveguide core 12. The dielectric material of the dielectric layer 22 is characterized by a refractive index that is less than the refractive index of the material constituting the waveguide cores 17. The alternating portions of the material constituting the waveguide cores 17 and the dielectric material of the dielectric layer 22 produce a refractive index for the metamaterial structure 16 alternates between a relatively higher value and a relatively lower value with increasing distance in a lateral direction from the waveguide core 12. The metamaterial structure 16 may be treated as a homogeneous material having an effective refractive index that is intermediate between the refractive index of the material constituting the waveguide cores 17 and the refractive index of the dielectric material constituting the dielectric layer 22.

Contacts 26 may be formed in the dielectric layer 22 that are respectively coupled to one of the waveguide cores 15 of the metamaterial structure 14. In an embodiment, the contacts 26 may be coupled to the waveguide core 15 that is arranged at a greatest distance away from the waveguide core 12. Contacts 28 may be formed in the dielectric layer 22 that are respectively coupled to one of the waveguide cores 17 of the metamaterial structure 16. In an embodiment, the contacts 28 may be coupled to the waveguide core 17 that is arranged at a greatest distance away from the waveguide core 12. The contacts 26, 28 may be comprised of a metal, such as tungsten, copper, or aluminum.

In an embodiment, the contacts 26, 28 may be used to apply a modulated electric field to the waveguide core 12 as a stimulus that causes the refractive index of its material to vary in proportion to the strength of the applied electric field according to the characteristic electro-optic coefficient of the material. The variation in the refractive index of the electro-optic material of the waveguide core 12 may be used to modulate propagating light being guided by the waveguide core 12. For example, the modulated light may be generated as a binary optical data stream by a modulated electrical signal that is applied through the contacts 26, 28 to vary the refractive index of the electro-optic material of the waveguide core 12. The metamaterial structures 14, 16 may function to steer and confine the light in closer proximity to the waveguide core 12.

The electro-optic phase shifter embodied in the structure 10 may be configured to function as a modulator with larger bandwidth and improved modulation efficiency in comparison with conventional electro-optic phase shifters. The alternating refractive index of the heterogenous materials of the metamaterial structures 14, 16 may function to increase the optical confinement factor, which enhances the modal overlap of propagating light with the electro-active material of the waveguide core 12 and strengthens the interaction of the propagating light with the electro-active material.

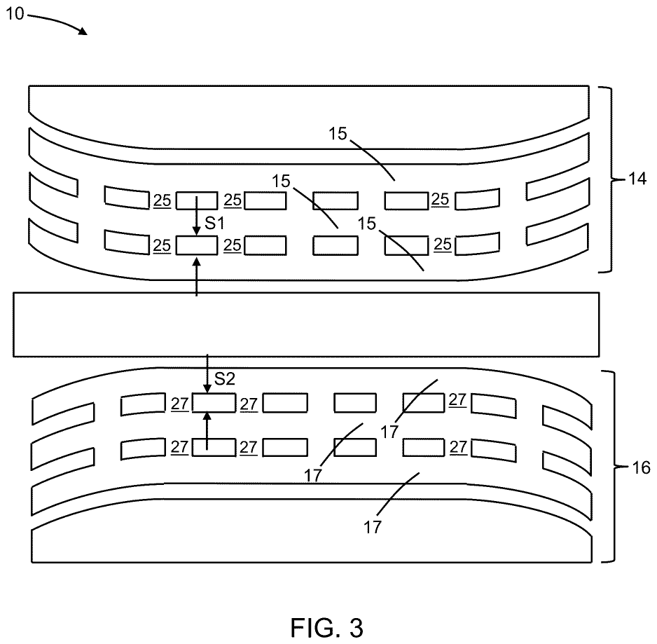

With reference to FIG. 3 and in accordance with embodiments of the invention, the waveguide cores 15 of the metamaterial structure 14 may be connected by bridging sections 25. The bridging sections 25 may extend fully across the slots S1 to connect adjacent pairs of the waveguide cores 15. Similarly, the waveguide cores 15 of the metamaterial structure 16 may be connected by bridging sections 27. The bridging sections 27 may extend fully across the slots S2 to connect adjacent pairs of the waveguide cores 17. The bridging sections 25 and the bridging sections 27 may be respectively comprised of the same material as the waveguide cores 15 and the waveguide cores 17, and may be patterned when the waveguide cores 15, 17 are patterned.

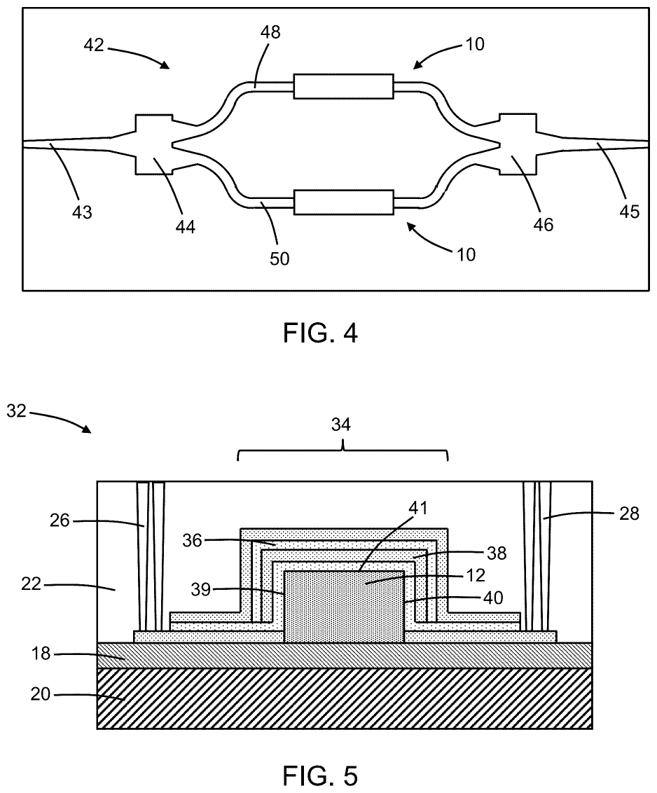

With reference to FIG. 4 and in accordance with embodiments of the invention, a Mach-Zehnder modulator 42 includes an input optical coupler 44, an output optical coupler 46, and waveguide cores 48, 50 representing arms that are separately routed from the input optical coupler 44 to the output optical coupler 46. An input waveguide core 43 is coupled to the input optical coupler 44, and an output waveguide core 45 coupled to the output optical coupler 46. The waveguide core 48 representing one arm of the Mach-Zehnder modulator 42 may integrate an instance of the electro-optic phase shifter embodied in the structure 10. The waveguide core 50 representing the other arm of the Mach-Zehnder modulator 42 may also integrate an instance of the electro-optic phase shifter embodied in the structure 10. The electro-optic phase shifters may be used to generate a phase difference between the light propagating in the different waveguide cores 48, 50 of the Mach-Zehnder modulator 42 for generating a modulated light signal from the output optical coupler 46. The modulation may be achieved by applying an electrical signal to the electro-optic material of the waveguide core 12 embedded in the electro-optic phase shifter.

The Mach-Zehnder modulator 42 may be integrated into a monolithic platform having a complete back-end-of-line stack. The Mach-Zehnder modulator 42 may be integrated with complementary-metal-oxide-semiconductor devices to form a hybrid high-performance radiofrequency integrated circuit or a hybrid high-performance logic integrated circuit. In an alternative embodiment, the phase shifter embodied in the structure 10 may be integrated into a ring modulator. In an alternative embodiment, the phase shifter embodied in the structure 10 may be integrated into a ring-assisted Mach-Zehnder modulator.

With reference to FIG. 5 and in accordance with embodiments of the invention, a structure 32 for an electro-optic phase shifter includes the waveguide core 12 and a metamaterial structure 34 that overlaps with the waveguide core 12. The waveguide core 12 and the metamaterial structure 34 are positioned on, and overlie, the dielectric layer 18 and the semiconductor substrate 20.

The metamaterial structure 34 includes portions of layers 36 and portions of layers 38 that wrap around the sidewalls 39, 40 and the top surface 41 of the waveguide core 12 as a layered cladding. The wrapped portions of the layers 36 alternate with the wrapped portions of the layers 38 with increasing distance from the sidewalls 39, 40 and the top surface 41 of the waveguide core 12. The wrapped portions of layers 36, 38 adopt the profile of the waveguide core 12, which may be, for example, rectangular or trapezoidal in cross-section. Some of the layers 38 including portions that extend laterally outward to permit coupling of the contacts 26, 28 to the structure 32. The wrapped portions of the layers 36 and the wrapped portions of the layers 38 partially surround the waveguide core 12. In an embodiment, one of the layers 36 may directly contact the sidewalls 39, 40 and top surface 41 of the waveguide core 12, and may separate the remaining layers 36, 38 from the waveguide core 12.

The layers 36 are comprised of a material having a different refractive index from the material of the layers 38. In that regard, the layers 36 may be comprised of a material characterized by a refractive index that is less than the refractive index of the material of the layers 38. In an embodiment, the layers 36 may be comprised of a dielectric material, such as silicon dioxide. In an embodiment, the layers 38 may be comprised of a material having a refractive index that is greater than the refractive index of silicon dioxide. In an embodiment, the layers 38 may be comprised of a semiconductor material, such as silicon. In an embodiment, the layers 38 may be comprised of a doped semiconductor material, such as doped silicon. The alternating heterogenous materials of the layers 38 and the layers 36 result in a refractive index for the metamaterial structure 34 that alternates between a higher value and a lower value with increasing distance from the waveguide core 12.

The structure 32 may represent an anti-resonant reflecting optical waveguide modulator. The layers 36, 38 of the metamaterial structure 34, which that are arranged on multiple sides of the waveguide core 12, provide multi-dimensional confinement of optical power. In particular, optical confinement is boosted by wrapped portions of the layers 36, 38 of the metamaterial structure 34 adjacent to the sidewalls 39, 40 and top surface 41 of the waveguide core 12.

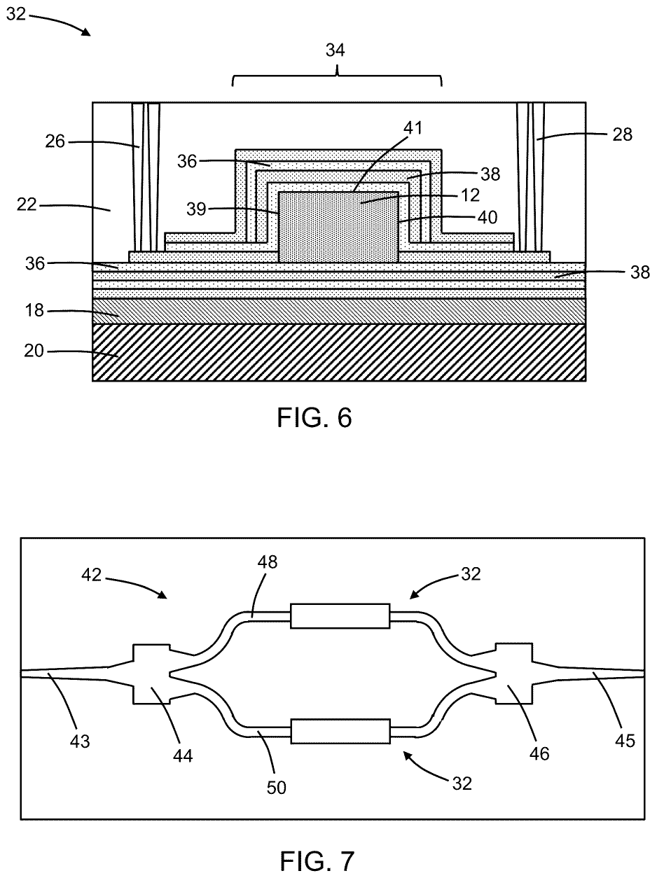

With reference to FIG. 6 and in accordance with embodiments of the invention, the metamaterial structure 34 may include additional alternating pairs of layers 36, 38 that are inserted between the bottom surface of the waveguide core 12 and the dielectric layer 18. The layers 36, 38 fully wrap around and surround the waveguide core 12 such that the waveguide core 12 is fully surrounded on all sides by the layers 36, 38 of the metamaterial structure 34 that provide the alternating refractive index. In that regard, the layers 36, 38 of the metamaterial structure 34 are positioned adjacent to the sidewalls 39, 40, top surface 41, and the bottom surface opposite from the top surface 41.

With reference to FIG. 7 and in accordance with embodiments of the invention, the Mach-Zehnder modulator 42 may include instances of the structure 32 for the electro-optic phase shifter in the arms represented by the waveguide cores 48, 50. In an alternative embodiment, the structure 32 for the electro-optic phase shifter may be integrated into a ring modulator. In an alternative embodiment, the structure 32 for the electro-optic phase shifter may be integrated into a ring-assisted Mach-Zehnder modulator.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction or plane in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or “directly contacting” another feature if intervening features are absent. A feature may be “indirectly on” or in “indirect contact” with another feature if at least one intervening feature is present. Different features may “overlap” if a feature extends over, and covers a part of, another feature. A feature may “overlie” another feature if a feature is positioned “over” another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a phase shifter, the structure comprising:
a first waveguide core comprising an electro-optic material; and
a first metamaterial structure adjacent to the first waveguide core, the first metamaterial structure including a first plurality of portions and a second plurality of portions that alternate with the first plurality of portions, the first plurality of portions comprising a first material having a first refractive index, and the second plurality of portions comprising a second material having a second refractive index that is less than the first refractive index.

2. The structure of claim 1 wherein the electro-optic material is lithium niobate, lithium tantalate, lithium niobate doped with magnesium oxide, or barium titanate.

3. The structure of claim 1 wherein the electro-optic material is a polymer.

4. The structure of claim 1 further comprising:
a second metamaterial structure laterally adjacent to the first waveguide core, the second metamaterial structure including a third plurality of portions and a fourth plurality of portions that alternate with the third plurality of portions, the third plurality of portions comprising the first material, and the fourth plurality of portions comprise the second material.

5. The structure of claim 4 wherein the first waveguide core is laterally positioned between the first metamaterial structure and the second metamaterial structure.

6. The structure of claim 1 wherein the first plurality of portions of the first metamaterial structure comprise a plurality of second waveguide cores and the second plurality of portions of the first metamaterial structure comprise a dielectric material that alternates with the plurality of second waveguide cores.

7. The structure of claim 6 further comprising:
a semiconductor substrate; and
a dielectric layer on the semiconductor substrate,
wherein the first waveguide core and the plurality of second waveguide cores are positioned on the dielectric layer.

8. The structure of claim 6 wherein the plurality of second waveguide cores are laterally separated by a plurality of slots, and the dielectric material is positioned inside the plurality of slots.

9. The structure of claim 8 wherein the first metamaterial structure includes a plurality of bridging sections that extend fully across the plurality of slots to connect adjacent pairs of the plurality of second waveguide cores.

10. The structure of claim 6 further comprising:
a contact coupled to one of the plurality of second waveguide cores.

11. The structure of claim 6 wherein the plurality of second waveguide cores comprise silicon.

12. The structure of claim 1 wherein the first plurality of portions of the first metamaterial structure comprise a first plurality of layers and the second plurality of portions of the first metamaterial structure comprise a second plurality of layers that alternate with the first plurality of layers.

13. The structure of claim 12 wherein the first waveguide core includes a first sidewall, a second sidewall opposite from the first sidewall, and a top surface between the first sidewall and the second sidewall, and the first plurality of layers and the second plurality of layers wrap around the first sidewall, the second sidewall, and the top surface of the first waveguide core.

14. The structure of claim 13 wherein one of the second plurality of layers directly contacts the first sidewall, the second sidewall, and the top surface of the first waveguide core.

15. The structure of claim 12 further comprising:
a semiconductor substrate; and
a dielectric layer on the semiconductor substrate,
wherein the first metamaterial structure includes a third plurality of layers and a fourth plurality of layers that alternate with the third plurality of layers, the third plurality of layers comprise the first material, the fourth plurality of layers comprise the second material, and the third plurality of layers and the fourth plurality of layers are positioned between the first waveguide core and the dielectric layer.

16. The structure of claim 1 wherein the first metamaterial structure fully surrounds the first waveguide core.

17. The structure of claim 1 wherein the first metamaterial structure partially surrounds the first waveguide core.

18. The structure of claim 1 further comprising:
a first optical coupler; and
a second optical coupler,
wherein the first waveguide core extends from the first optical coupler to the second optical coupler, and the first metamaterial structure is arranged adjacent to a portion of the first waveguide core.

19. The structure of claim 1 wherein the first metamaterial structure is configured to increase optical confinement proximate to the first waveguide core.

20. A method of forming a structure for a phase shifter, the method comprising:
forming a waveguide core comprising an electro-optic material; and
forming a metamaterial structure adjacent to the waveguide core, wherein the metamaterial structure includes a first plurality of portions and a second plurality of portions that alternate with the first plurality of portions, the first plurality of portions comprises a first material having a first refractive index, and the second plurality of portions comprise a second material having a second refractive index that is less than the first refractive index.
